(19) United States
(12) Patent Application Publication
(10) Pub. No.: US 2026/0152019 A1
(43) Pub. Date: Jun. 4, 2026

(54) LENS-LESS LASER ENGRAVED MOTION IMAGE IN LOOK-THROUGH ELEMENT

(71) Applicant: Idemia Identity & Security USA, LLC, Reston, VA (US)

(72) Inventors: Juliet SOOHOO, Needham, MA (US); Garret OZBOLT, Somerville, MA (US); William O'CONNOR, Derry, NH (US)

(73) Assignee: Idemia Identity & Security USA, LLC, Reston, VA (US)

(21) Appl. No.: 18/965,773

(22) Filed: Dec. 2, 2024

(51) Int. Cl. B42D 15/08

(52) U.S. Cl. CPC B42D 15/08; B42D 25/00; B42D 25/22; B42D 25/23

(57) ABSTRACT

A substrate for security verification, including a first substrate layer including a first transparent region; a second substrate layer including a second transparent region; and an intervening substrate layer between the first substrate layer and the second substrate layer including an intervening transparent region positioned with respect to the first and second transparent regions, wherein the first substrate layer includes a first image that is laser-engraved on the first transparent region and the second substrate layer includes a second image deposited on the second transparent region, the first image and the second image being configured to interact to create a visual dynamic pattern when a viewing angle of the substrate changes.

### BACKGROUND

### Field of the Disclosure

The present disclosure relates to the design and structure of substrates having security features.

### Description of the Related Art

The addition of security features to documents can prevent forgeries of said documents. Such security features can be applied to documents such as passports or identification cards. Lenses can be used to create a dynamic visual effect in a security feature.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction and are not intended to limit the scope of the following claims. The described embodiments, together with further advantages, will be best understood by reference to the following detailed description taken in conjunction with the accompanying drawings.

In one embodiment, the present disclosure is related to a substrate for security verification, comprising a first substrate layer including a first transparent region; a second substrate layer including a second transparent region; and an intervening substrate layer between the first substrate layer and the second substrate layer including an intervening transparent region positioned with respect to the first and second transparent regions, wherein the first substrate layer includes a first image that is laser-engraved on the first transparent region and the second substrate layer includes a second image deposited on the second transparent region, the first image and the second image being configured to interact to create a visual dynamic pattern when a viewing angle of the substrate changes.

In one embodiment, the present disclosure is related to a substrate for security verification, comprising a first substrate layer including a first transparent, laser-markable region; a second substrate layer including a second transparent region; and an intervening substrate layer between the first substrate layer and the second substrate layer including an intervening transparent region positioned with respect to the first transparent, laser-markable region and the second transparent region, wherein a first outer surface of the first substrate layer includes a first laser-engraved image on the first transparent, laser-markable region, a first inner surface of the first substrate layer or a second inner surface of the second surface layer includes a printed image, a second outer surface of the second substrate layer includes a second image deposited on the second transparent region, and the first transparent, laser-markable region and the second transparent region are partially overlapping.

In one embodiment, the present disclosure is related to a method of forming a substrate for security verification, comprising: collating a first substrate layer having a first transparent region, a second substrate layer having a second transparent region, and an intervening substrate layer having an intervening transparent region between the first substrate layer and the second substrate layer; engraving a first image via laser engraving on the first transparent region of the first substrate layer; and depositing a second image on the second transparent region of the second substrate layer, wherein the intervening transparent region is positioned with respect to the first transparent region and the second transparent region.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A is a cross-section of a security feature according to one embodiment of the present disclosure;

FIG. 1B is a top-down view of a laser engraved image of a security feature according to one embodiment of the present disclosure;

FIG. 1C is a cross section view of a laser engraved image of a security feature according to one embodiment of the present disclosure;

FIG. 2 is an illustration of security feature images according to one embodiment of the present disclosure;

FIG. 3 is an illustration of an effect of movement or change of visual appearance formed by the first and second image according to one embodiment of the present disclosure;

FIG. 4A is an illustration of the direction of movement along the X axis in one embodiment of the present disclosure;

FIG. 4B is an illustration of the direction of movement along the Y axis in one embodiment of the present disclosure;

FIG. 4C is an illustration of two movement directions accommodated simultaneously in one embodiment of the present disclosure;

FIG. 5 is an illustration example of the effect when the first and second images are placed together over a clear or translucent layer of predetermined thickness according to one embodiment of the present disclosure;

FIG. 6 is an illustration of security feature functions when viewed in x axis, according to one embodiment of the present disclosure;

FIG. 7 is an illustration of how the security feature can be used to personalize data in two different embodiments of the present disclosure;

FIG. 8 is an illustration of a layers in a substrate according to one embodiment of the present disclosure;

FIG. 9 is a method of fabricating a substrate according to one embodiment of the present disclosure;

FIG. 10 is an example of a laser profile including beam train parameters (BTP) according to one embodiment of the present disclosure;

FIG. 11 is an illustration of layers in a substrate according to one embodiment of the present disclosure; and

FIG. 12 is a method of fabricating a substrate according to one embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

“Laser engraving” refers to carbonizing rather than removing polymeric material from a substrate with a laser. Laser engraving of a substrate does not ablate material from the substrate (for example it does not create micro-perforations) but only results in carbonization, darkening of material.

In one embodiment, the present disclosure is directed to a substrate having a physical security feature. In one embodiment, the substrate can be a security document, such as a page in a passport or a document used for conveying confidential or verified information. In one embodiment, the substrate can be a card, such as a payment card, identification card, access card, etc. Physical features of the substrate can convey information via visual interactions with the substrate. For example, the substrate can include an image that is engraved onto the substrate. In one embodiment, a physical security feature (or “security feature”) can be used to verify the origin, ownership, or legitimacy of the card. In one embodiment, a security feature can include personalized information, e.g., information about a substrate manufacturer, issuer, owner, user, etc.

In one embodiment, the security feature can create a visual effect that can be easily verified without specialized optical instruments. The visual effect can be, for example, a simulation of movement or change in the appearance of the security feature when the viewing angle of the security feature changes. The visual effect occurs due to the parallax effect resulting from the interaction between the first and second images, separated by a transparent spacing, as the eye moves over them. The arrangement of the first and second images can form a dynamic (moving) pattern such as a Moiré pattern, and the dynamic pattern can appear to move as the eyes move across the substrate. The viewing angle of the substrate can refer to an orientation or angle of the substrate relative to a viewer. In one embodiment, the visual effect can include a change in the appearance of the security feature as the viewing angle changes. For example, the security feature can appear as a first composite image (e.g., a first visual pattern) at a first viewing angle and a second composite image (e.g., a second visual pattern) at a second viewing angle. As an example, the composite image can be the Moiré pattern. In one embodiment, the visual effect can be an appearance of light (or shadow) moving across the security feature as the viewing angle changes, or a change of contrast (brightness) as the viewing angle changes. The appearance of the security feature (e.g., the composite images) at a given viewing angle depends on the interaction (e.g., overlap) between the one or more individual (first and second) images at the viewing angle.

In one embodiment, the security feature can include variable or dynamic data that can be personalized for each application (implementation) of the security feature. For example, the security feature can include unique visual information such as a serial number, personalized text, an image, etc. An effective security feature having variable data can be reprogrammed or redesigned to include the variable data for each application. For example, a security feature that is laser engraved onto a substrate can be designed so that each laser engraving includes a different set of variable data. In one embodiment, the security feature can include a first image and a second image. Each image can include variable data. The variable data can be in the form of a pattern. The security feature effect or appearance can result from the two different sets of variable data as patterns of the first and of the second images. For example, the first pattern of the first image can be a personalization pattern and the second pattern of the second image can be a parallax or interactive pattern. The first pattern and second pattern can be related to create the composite image (e.g., visual pattern) also called the Moiré pattern.

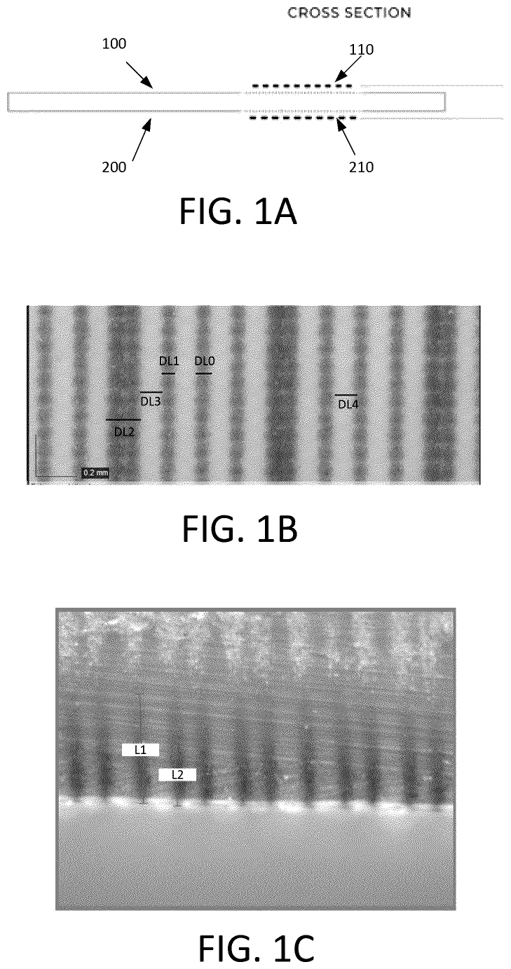

FIG. 1A is a cross-section of a security feature according to one embodiment. In one embodiment, the security feature can include a first image 110 at a first location on a first surface (“top surface,” “front surface”) 100 of a layer and a second image 210 at a second location on the opposing surface (“bottom surface,” “back surface”) 200 of the layer. The first location and the second location can be positioned with respect to each other. For example, the first location and the second location can be aligned, overlapping, etc. In one embodiment, both images can be laser engraved on a surface. In one embodiment, one of the first image or the second image can be laser engraved and the other of the first image or the second image can be printed (for example with a laser toner-based printing system, laser drum-based printing system, an inkjet printing system, a digital printing press, an analog printing press, a digital offset printing system) on a surface with high resolution. For example, the variable data of the first image can be embedded and laser engraved into the first image and can interact with a high-resolution printed pattern (e.g., interactive pattern) of the second image. Laser engraving allows for the data or security pattern to be personalized for each substrate. In one embodiment, at least a portion of the first image can overlap with at least a portion of the second image. For example, the first location can be positioned with respect to the second location such that the first image 110 and the second image 210 are fully overlapping, as illustrated in FIG. 1. In one embodiment, a portion of the body of the layer between the first and the second image can be partially or fully transparent, thus forming a see-through window. A transparent material as used herein can include a fully transparent (e.g., clear) or a partially transparent (e.g., translucent) material. In one embodiment, a cutout can be formed through the body of the layer. For example, the substrate layer can be an opaque material. The cutout can be created by removing a portion of the opaque material from the body of the layer. In one embodiment, the cutout in the substrate layer can be filled with a plug of a partially or fully transparent material, e.g., a clear, plastic. The plug can provide a spacing between the first image and the second image for the parallax effect. In one embodiment, the assembly of the plug and the layer can form a prelaminate. In one embodiment, the plug can be laser markable at the location of the first and second image and the first image 110 and the second image 210 can be laser-engraved on opposing external surfaces of the plug. In this manner, a first external surface of the plug can be the first surface having the first image and an opposing external surface of the plug that is parallel to the first surface can be the second surface having the second image. In one embodiment, the plug fill material can be tinted, patterned, etc. while maintaining a degree of transparency.

In one embodiment, the body of the layer can include the cutout forming the see-through window and each side of the layer can include a transparent laser-markable film covering externally the transparent see-through window of the opaque core layer. The first image 110 can be laser engraved on transparent laser-markable film on a first surface covering the transparent window, and the second image 210 can be laser engraved on transparent laser-markable film on a second surface covering the transparent see-through window. The configuration allows the security pattern to be dynamic without the use of lenses. Additionally, the laser engraving allows personalization data to be incorporated in the security feature, and allowing the security pattern to be custom to each card holder increases the level of difficulty for tampering. Moreover, the security feature protects against a simulated or counterfeit feature as the first and second images interact together to achieve the movement pattern.

FIG. 1B is a top-down view of a laser-engraved image of a security feature (e.g., the first image 110) with 600 DPI 4 mm offset. The width of the features in the laser-engraved image can vary. For example, a first line DL2 can be approximately 0.077 mm in width; a second line DL1 can be approximately 0.032 mm in width; a third line DL0 can be approximately 0.034 mm in width; a first spacing between lines DL3 can be approximately 0.044 mm; and a second spacing between lines DLA can be approximately 0.045 mm.

FIG. 1C is a cross sectional view of a laser engraved image of a security feature (e.g., the first image 110) representing the laser bed depth. As an example, a laser engraving can be 5.533 mil in depth with a bed of 10.035 mil.

In one embodiment, the first surface having the first image and the second surface having the second image can be separated by a distance. The distance can be, for example, the thickness of the layer having the first surface and the second surface. In one embodiment, the distance between the first surface and the second surface can be at least 0.1 millimeters (mm). The distance between the first image and the second image can result in the parallax effect of the security feature at different viewing angles. For instance, when the first image and the second image are not separated by a distance, the security feature can be a static image that does not change at different viewing angles. A gap between the first image and the second image can result in varying overlap of elements in the images at different viewing angles. As the distance between the images increases, the change in appearance of the security feature can be more pronounced at smaller changes in viewing angle. In one embodiment, the distance between the first image and the second image can be related to a size, resolution, or spacing of elements in the images.

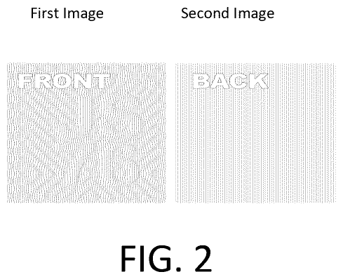

FIG. 2 is an illustration of a first image and a second image of a security feature according to one embodiment. The first image can include a first pattern while the second image includes a second pattern. The first pattern can be different from the second pattern. In one embodiment, the first pattern can be similar to or the same as the second pattern but can be transformed, e.g., rotated, offset, scaled, having a different pitch, etc. and designed to create a dynamic (moving) pattern, such as a Moiré pattern, that reveals movement, text or artwork from the images. In one embodiment, the patterns can include a series of opaque elements such as lines or shapes (organic or geometric shapes). For example, the first image of FIG. 2 includes a pattern of diagonal lines and circles, and the second image of FIG. 2 includes a pattern of vertical lines. In one embodiment, the image can include elements (such as lines or dots) of varying density, direction and thickness of pattern. In one embodiment, the density of the elements can simulate a gradient, as in the vertical lines of the second image. The patterns can be engraved onto the substrate with a laser. Each image can be visible through gaps in the pattern of the other image when the images are deposited on a transparent layer or layers.

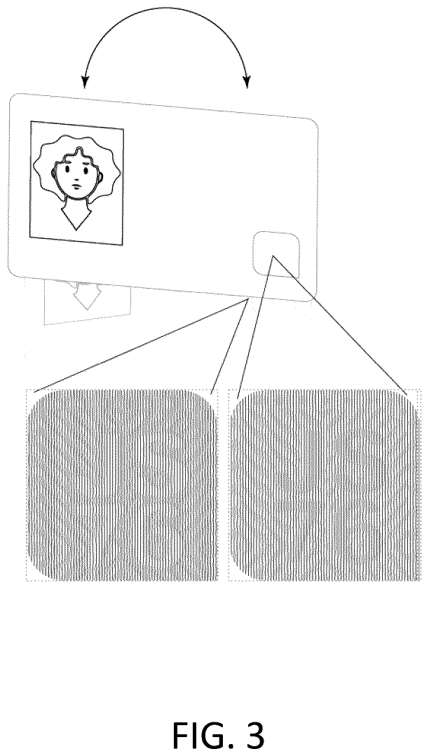

FIG. 3 is an illustration of a substrate having a security feature according to one embodiment. The security feature can include a first image of the first pattern of FIG. 2 and a second image of the second pattern of FIG. 2. In one embodiment, the first image (e.g., the personalization pattern) is laser engraved and the second image (e.g., the interactive pattern) can be laser engraved or printed on the opposing surface (e.g., back surface) of another layer beneath. In one embodiment, the first image and the second image can each be laser engraved on separate facing layers. The first image and the second image can be overlapping. In one embodiment, the overlap of the first and second images can form a Moiré pattern. The Moiré pattern can be a third pattern or image that is distinct from the first or second images forming the security feature. In one embodiment, the overlap of the first image and the second image can create a parallax effect such that an appearance of the security feature varies with the viewing angle. For example, at a first viewing angle, the overlap of the first image and the second image can result in a patterned image including the text “JS76.” At a second viewing angle, the overlap of the first image and the second image can result in a different patterned image wherein the text “JS76” is less visible. In one embodiment, the first viewing angle can be when the user is looking at the front surface of the layer, while the second viewing angle can be when the user is looking at the back surface of the layer.

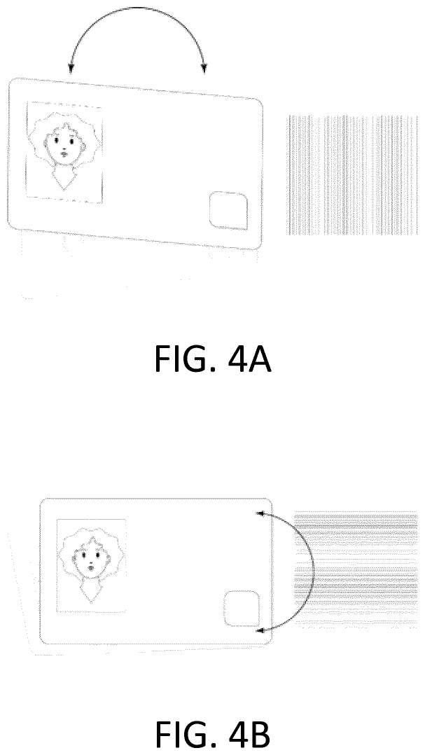

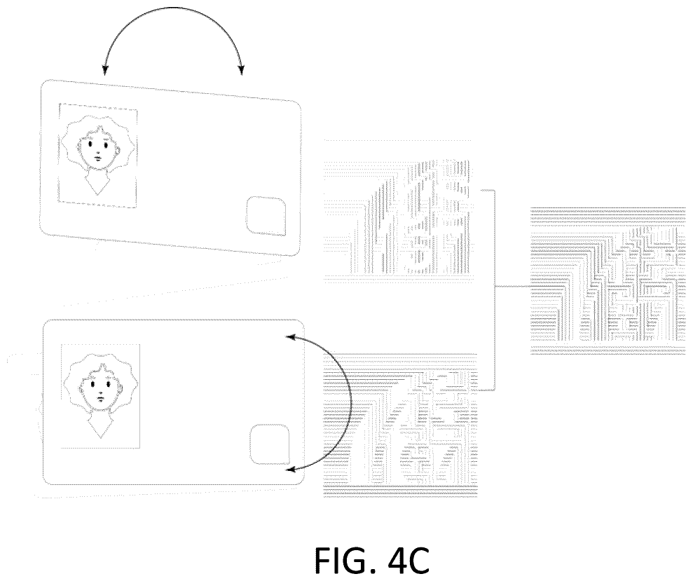

In one embodiment, the first image or the second image can include a pattern of parallel lines, as in the second pattern of FIG. 2. The pattern of lines can create a directional parallax effect. In general, the appearance of the security feature can change when the substrate is tilted along an axis that is perpendicular to the lines of the pattern. For example, FIG. 4A illustrates a security feature in one embodiment, wherein one image (e.g., the second image) is a pattern of vertical lines. The appearance of the security feature can change when the substrate is tilted from left to right, e.g., along an x-axis. FIG. 4B illustrates a security feature wherein one image (e.g., the second image) is a pattern of horizontal lines in one embodiment. The appearance of the security feature can change when the substrate is tilted vertically as illustrated, e.g., along a y-axis. FIG. 4C illustrates a security feature in one embodiment, wherein an image includes a combination of horizontal and vertical lines. A parallax effect can be observed when the substrate is tilted from left to right as well as vertically, e.g., along both x and y axes. The images are optimized differently between these different embodiments to create the parallax effect for horizontal tilt or vertical tilt.

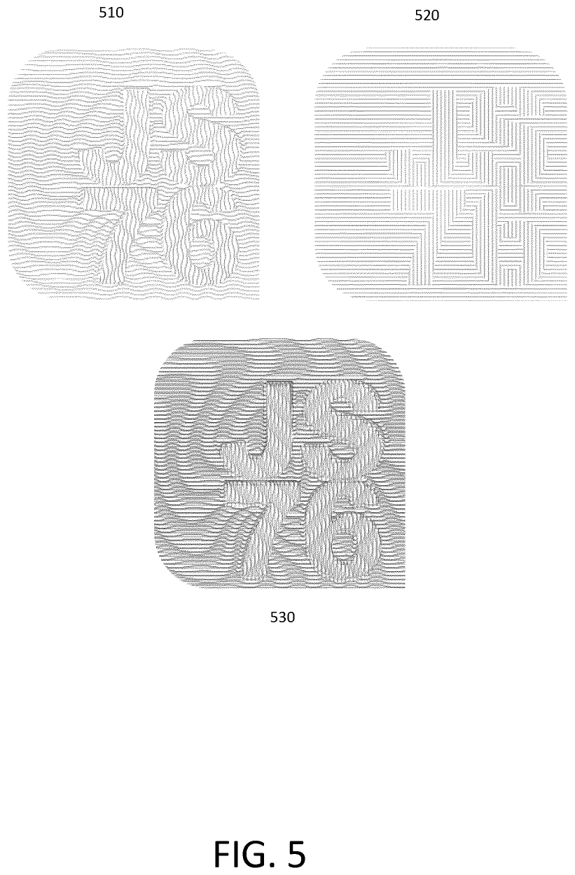

FIG. 5 is an illustration of a first pattern 510 (e.g., the personalization pattern), a second pattern 520 (e.g., the interactive pattern), and an overlap of the first pattern and the second pattern according to one embodiment creates the Moiré pattern 530. The first pattern 510 can include curved (wavy) vertical lines, while the second pattern 520 can include straight vertical lines. In one embodiment, the density of the lines in each pattern can vary. For example, the first pattern 510 illustrated in FIG. 5 includes regions of alternating curves that interact with the second pattern 520.

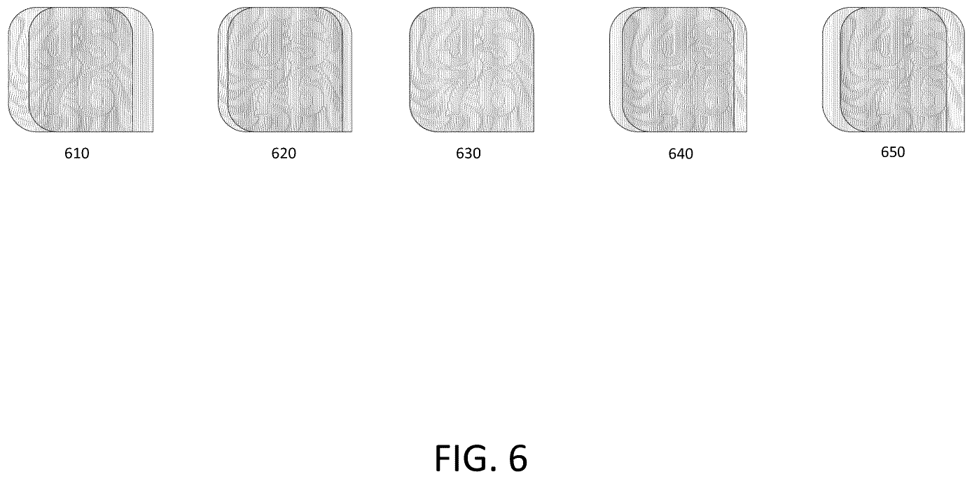

FIG. 6 is an example of X-axis oriented pattern illustrating the interaction between the first pattern 510 and the second pattern 520 viewing from left to right of FIG. 5 according to one embodiment. The viewing angle of the security feature can affect an amount of visible overlap between the first pattern and the second pattern when the first pattern and the second pattern are separated by a distance. The viewing angle can be an angle between the plane of the security feature and the viewer. For example, at a first viewing angle 610 from the left side of the security feature, the right side of the top pattern (the first pattern) overlaps with the left side of the bottom pattern (the second pattern) to create a first Moiré pattern. As the viewer approaches a position that is perpendicular to the plane of the security feature, the overlap between the patterns increases (e.g., at viewing angle 620) until the first pattern is fully overlaid on the second pattern at viewing angle 630. As the viewer moves to the right of the security feature (e.g., at viewing angles 640, 650), the overlap between the patterns can decrease, resulting in a different Moiré pattern. In one embodiment, the tilting/viewing range illustrated in FIG. 6 can vary approximately between +30 to −30 degrees.

As an example, a first image can include a first pattern of non-uniform horizontal lines. The horizontal lines of the first pattern can include variations such as waves, bumps, etc. The horizontal lines of the first pattern can form a letter or image. For example, the density, brightness, thickness, or spacing of the lines (or portions of the lines) can vary to form a letter or image. A second image can include a second pattern of uniform horizontal lines. The first image and the second image can be overlaid in the security feature. The appearance of the security feature can change when the viewing angle of the security feature changes. For example, the visibility of the letter or image in the first pattern can vary with the viewing angle of the security feature.

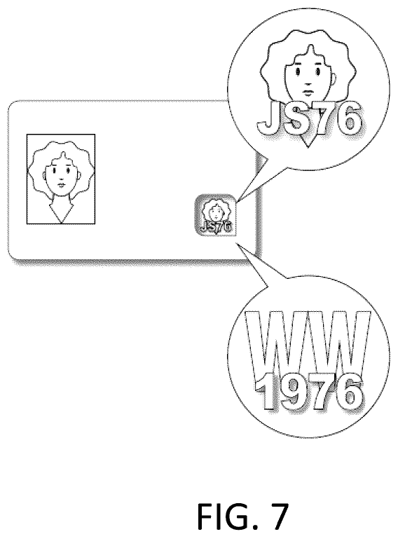

In one embodiment, an image of the security feature (e.g., the first image) can include text or an illustration. For example, FIG. 7 illustrates a substrate wherein the first image of the security feature can include a portrait or text information. In one embodiment, the portrait or text information can be personalized for each user (owner, recipient, etc.) of the substrate. In this manner, the security feature can be customizable and can therefore be more effective for validating the substrate. In one embodiment, the combination of the first image and the second image can create a three-dimensional effect. For example, the first image can be a portrait. The first image can include any pattern in addition to the portrait. The second image below the first image can include a depth map as an interactive pattern having different density in positions that correspond to regions of depth or distance in the first image. In one embodiment, the first image and the second image can be generated based on a single image. The combination of the first image and the second image can include more variation in image brightness than may be achieved using a single black-and-white monochrome laser image or greyscale laser image. In one embodiment, the combination of the first image and the second image can simulate a half-tone image with tonal values (for example considering 255 tonal values).

In one embodiment, the security feature can include images fabricated on separate layers. For example, a first image can be laser engraved on a first layer, and a second image can be fabricated on a second layer. Each layer can be partially or fully transparent at the location of the image. The first layer and the second layer can be stacked upon each other so that the first image is overlapping with the second image. In one embodiment, the distance between the first image and the second image can be formed by one or more layers. For example, the first image is laser engraved on a top surface of the first layer. The second image including an interactive pattern can be fabricated on a top surface of a second layer. The first image and the second image can be separated by the thickness of the first layer. In one example, the second image can be fabricated on a back surface of the second layer. The first image and the second image can thereby be separated by the combined thickness of the first and second layers.

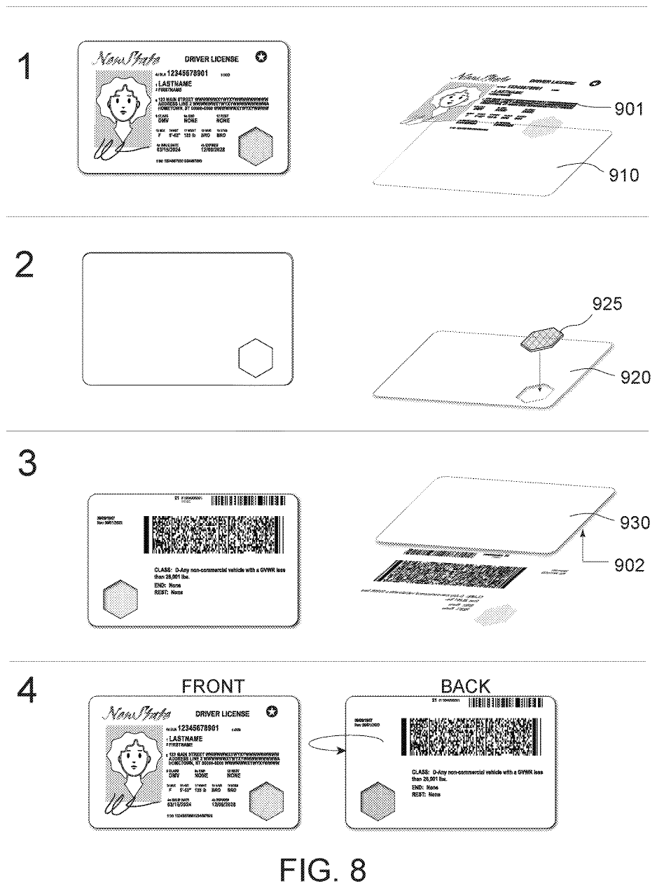

In one embodiment, the first layer and the second layer can be separated by one or more intervening layers. For example, FIG. 8 is an illustration of a stack of layers forming a substrate according to one embodiment. The first image 901 having a first pattern can be laser engraved on a top surface of a first security layer 910. In one embodiment, the region of the first security layer 910 at which the first image 901 is located represents the laser engraved data. For example, the first security layer 910 is the laser-markable laminate. In one embodiment, the first security layer 910 can further be laser engraved with additional image data. The laser engraved image 901 can include a data set with integrated front personalization image pattern on the clear, outward-facing side of the first security layer 910.

In one embodiment, the substrate can further include an intervening layer 920 having a transparent window. In one embodiment, the intervening layer 920 can be transparent. For example, the transparent window can be a transparent region of the intervening layer 920. In one embodiment, the intervening layer 920 can be an opaque layer. A cutout can remove (e.g., punch out) the opaque material from the body of the intervening layer 920 to form the transparent window. In one embodiment, the cutout can be filled by a plug 925 of a partially or fully transparent material (transparent or translucent). The plug 925 can be a laser-markable material that fills (partially or completely) in the spacing of the cutout window in the punched layer 920. The plug 925 can be the same thickness of the intervening layer 920 so that each surface of the layer 920 is flat when the plug 925 is inserted. The plug 925 can enable visibility of the layers beneath the layer 920. The plug can be located at the location of the first image 901 on the first security layer 910.

The substrate can include a second security layer 930. The second security layer 930 can include a second image 902 at a location that is in alignment with the first image 901 on the first security layer 910 and the plug 925. The second security layer 930 can include a cutout window that is aligned with the window of the layer 920. The region of the second security layer 930 at which the second image 902 is fabricated can be a laser-markable material. The second image 902 can include a back laser-engraved data set with an interactive pattern. The second image 902 can be laser-engraved on a clear outward-facing side of the second security layer 930. The second image 902 can be printed on the top surface of the second security layer 930 or laser engraved on the bottom surface of the second security layer 930. In one embodiment, the second security layer 930 can be opaque, and the second image 902 including the interactive pattern can be fabricated on the top surface of the opaque second security layer 930. In one embodiment, the second image 902 can be printed on the top surface or laser engraved on the bottom surface when the second security layer 930 is transparent (e.g., a clear laminate). In one embodiment, layers 910, 920, 930 are polycarbonate (or for example PET, PETG) layers. In one embodiment, the second security layer 930 can be a laser-markable transparent back film.

When the layers 910, 920, 930 are assembled, the substrate can have a single cutout window shape at a location on the substrate that is visible from the front side and the back side of the substrate. The transparent portions (e.g., the security layers, the plug) of the substrate illustrated in FIG. 8 include 901 representing the laser engraved data and the second image 902 representing the Back Laser Engraved data. Furthermore, the intervening layer 920 between the first security layer 910 and the second security layer 930 creates a distance between the first image 901 and the second image 902 that results in the parallax effect when viewing the substrate at different viewing angles. It can be appreciated that the number and order of layers illustrated in FIG. 8 are presented as a non-limiting example of the present disclosure, and that more or fewer layers (including intervening layers) are possible. In addition, the first and second image can be fabricated on any combination of layer surfaces presented in FIG. 8 provided that the images are not fabricated on the same surface or directly adjacent surfaces (e.g., surfaces that are in contact).

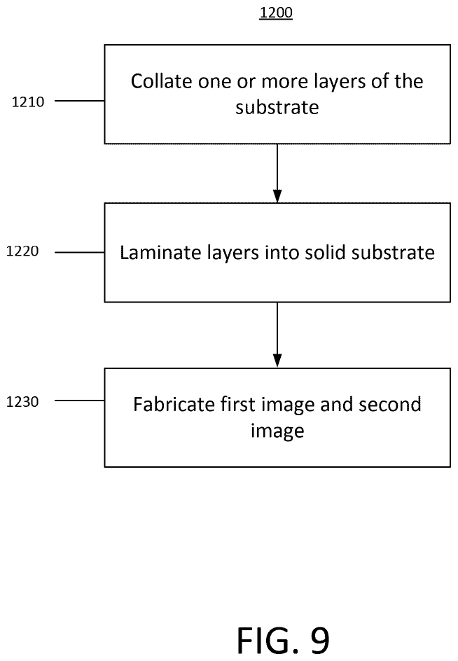

FIG. 9 is a method 1200 of fabricating the substrate according to one embodiment. In step 1210, one or more layers of the substrate can be collated. The one or more layers can include plastic layers, paper layers, resin layers, and/or metal layers. In an embodiment wherein the substrate includes layers that are not locally transparent in the region of the see-through window, a cutout can be formed individually through each layer of the substrate or can be formed in the assembled layers in order to create the spacing that can receive a transparent plug. The cutout window can be formed by removing (e.g., punching) a window through the substrate as a whole after the layers are collated. In an example in step 1210 a first layer 910 of transparent, laser-markable film on top of a prelaminated intervening layer 920 being transparent in the see-through window region on top of a second layer 930 of transparent, laser-markable film are assembled. All layers are stacked and collated together to form the substrate. The external surfaces of the assembly are laser markable in the region of the see-through window and form the location of the laser engraving of the first and second images.

In one embodiment, to create the prelaminate, a plug of a transparent material can be placed in a cutout of the intervening layer to create the transparent window that aligns with transparent regions of the first layer 910 and the second layer 930. The thickness (height) of the plug can match the thickness (height) of the cutout and the surrounding layers. The thickness of the plug can be approximately the distance separating the first image and the second image of the security feature. The plug can be fully or partially transparent. In one embodiment, the plug can be tinted, patterned, etc. while maintaining a degree of optical clarity. The plug can be a laser-markable material including, but not limited to, polycarbonate, polyethylene terephthalate (PET) and/or similar polymers (e.g., glycol-modified (PET-G), polyethylene furan-2,5-dicarboxylate (PET-F or PEF)). In one embodiment, the substrate can be laminated after the plug is inserted into the cutout. In this case, the outer (e.g., outermost) layer of the substrate can be a transparent and laser-markable laminate material described herein.

In step 1220, the assembly is fused into a solid card body, especially by lamination process.

In step 1230, the first image 901 and the second image 902 can be fabricated on the substrate. The first image can be fabricated on a first surface (side) of the substrate at the location of the see-through window. The second image can be fabricated on an opposing second surface (side) of the substrate at the location of the see-through window. In one embodiment, the first image and the second image can be fabricated via laser engraving. A laser can heat the laser-markable surface of the substrate to cause a controlled amount of discoloration (darkening). In one embodiment, the laser can be a neodymium-doped yttrium aluminum garnet (Nd: YAG) laser, or ultraviolet laser. In one embodiment, the laser marking can be used to create different shades in the image. For example, increased laser intensity can result in a darker region of the image. The laser can be fine-tuned for a smooth or gradual change in laser intensity. A smooth change in laser intensity can result in smooth, blended brightness gradients across the image. In one example, on a Muhlbauer CLP60 fiber laser, with a marking speed of 2.560 mm/s a laser power range: 15-30% (e.g., of a maximum power) and a frequency range: 40-105 kHz can be used.

In one embodiment, the transparent plug can be a laser-markable material. In one embodiment, an image (e.g., the first image having a personalization pattern or the second image having an interactive pattern) can be fabricated on the transparent plug itself. In one embodiment, the image on the transparent plug can be a different image or pattern from the first and second images described herein.

In one embodiment, one of the first image and the second image can be printed. As an example, gravure or flexo printing can be used to create an image on the transparent plug with optical variable material ink. Pre-printing a pattern on the plug can increase laser production throughput by replacing a laser engraving step for one of the patterns. This method can also allow the exploration of combining laser engraving with color printing to potentially allow more chromatic effects to be seen, which can be a benefit for counterfeit protection.

In one embodiment, the substrate can be imaged to generate an image of the substrate during the manufacturing process. The image of the substrate can be processed via computer vision to identify the location of the plug at the first surface and the second surface. The location that is identified via computer vision can then be used to position the laser to engrave the images at the plug. In this manner, the images can be fabricated at the transparent region in the substrate body.

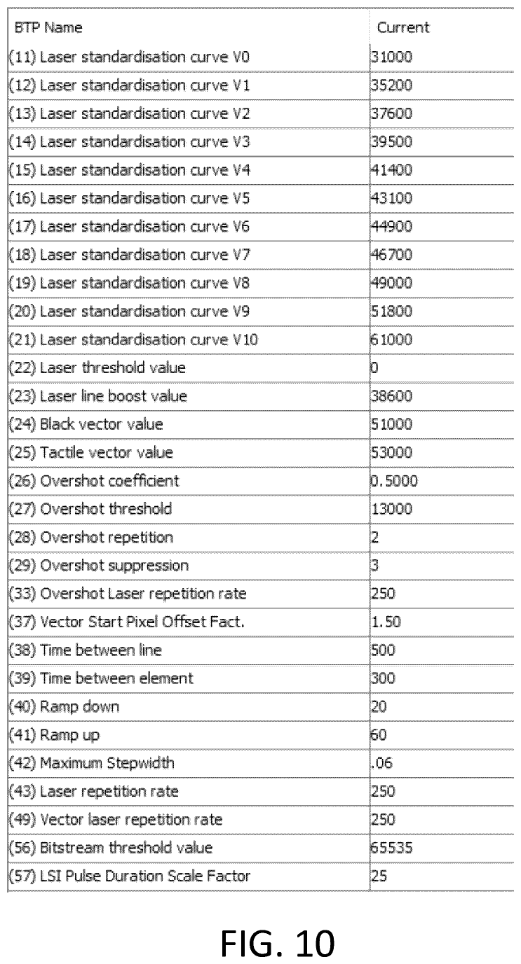

FIG. 10 is a table of example laser profile BTP parameters that can be used to create the first and/or second image on a substrate layer. In one embodiment, the laser focal distance (focal offset) can be approximately 4 mm. In one embodiment, a bitmap of an image (e.g., the first image) can be a 12.7 mm by 12.7 mm (or 300 pixels by 300 pixels) bitmap with a 600 dots per inch (dpi) resolution. In one example, a laser can engrave an element (e.g., a dot) having a width of approximately 32 microns at 600 dpi. In one example, a laser can engrave an element (e.g., a dot) having a width of approximately 40 microns at 1200 dpi. A spacing between lines can therefore be approximately 40 microns at 1200 dpi resolution. In one embodiment, the laser can engrave the surface in a horizontal direction with a unidirectional scan and one scan line repetition. The intensity of the laser can vary to create a grayscale image. In one embodiment, the pixel and element repetition can each be 1. In one embodiment, the spacing between laser engraved layers can be between approximately 250 to approximately 450 microns. Larger and smaller spacings can also be compatible. As an example, a laser engraved layer can be approximately 260 microns in thickness and the laser engraving can be approximately 140 microns in depth.

In one embodiment, the images can have a resolution of approximately 400 dpi to approximately 1200 dpi. In one embodiment, an element in the image can have a minimum width of approximately 30 microns. For example, the element can be an opaque line having a thickness of 30 microns. As an example, the image can include lines having varying thicknesses, e.g., 0.044 mm, 0.032 mm, 0.077 mm, 0.034 mm, 0.045 mm. Larger and smaller elements are also compatible with the images described herein. In one embodiment, the pattern of an image can include opaque lines that are spaced approximately 30 microns apart. In one embodiment, the depth of the laser engraved image can be up to approximately 400 microns. A laser engraving of a surface removes material from the surface via vaporization. Variation in the amount of material that is removed results in variation in the color (brightness) of the engraving. However, it can be desirable to engrave a shallow image to prevent the three-dimensional nature of the engraving from affecting the parallax of the security feature.

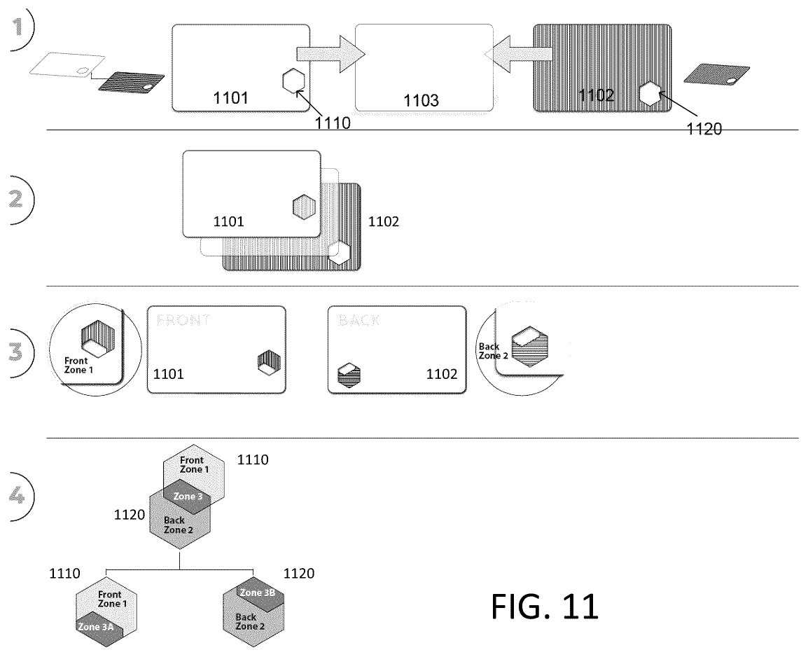

FIG. 11 is an illustration of substrate layers according to one embodiment. The substrate can include a first (top) layer 1101. The first layer 1101 can be an opaque, layer having a cutout window 1110 through the top and bottom surfaces, which can be filled with a transparent laser-markable plug.

The first layer 1101 can include on its inner (relative to the stacking of the layers in the substrate, i.e., back, bottom of the first layer) surface an image on its whole surface or at least in the vicinity of the cutout window. The image on the inner surface can be a high-resolution printed image (“first printed image”). The first printed image on the inner surface can include an interactive pattern. In one embodiment, the first layer 1101 can include a first laser-engraved image that can be integrated by laser engraving on the outer (upper, top) surface at the location of the cutout window (transparent region) of the first layer 1101. In one embodiment, the first laser-engraved image can include a pattern, e.g., a personalization pattern. In one embodiment, the first laser-engraved image can be laser-engraved directly on the upper surface of the first layer 1101 when the first layer is a laser-markable material. For example, the first laser-engraved image can be laser-engraved on the transparent plug in the window 1110. In one embodiment, the first layer 1101 can be laminated or otherwise covered with an additional external transparent layer, such as a laser-markable film that can be added on top of the first layer, the first laser-engraved image being engraved in a region of the external surface overlapping the cutout window in the first layer 1101.

The first layer 1101 can be deposited facing a second layer 1102 with a spacer film (intervening) layer as a third layer 1103 between them, the spacer film being transparent or translucent in a region of the external surface overlapping the cutout windows in the first layer 1101 and second layer 1102. The spacer film can be a transparent or translucent layer.

The second layer 1102 can be an opaque layer having a cutout window 1120 through the top and bottom surfaces. The cutout in the second layer 1102 can be filled with a transparent laser-markable plug. The inner (top) surface of the second layer 1102 can include an image printed on most or all of the inner surface of the first layer 1101 or at least in the vicinity of the cutout window of the second layer. The image printed on the top surface of the second layer 1102 can be a second printed image having an interactive pattern. For example, in the illustrated embodiment of FIG. 11 the image printed on the top surface of the second layer 1102 represents a graphic comprising vertical lines.

The second layer 1102 can include a second laser-engraved image that can be integrated by laser engraving on the outer (bottom, back) surface of the transparent region of the second layer 1102. In one embodiment, the second laser-engraved image can include a pattern, e.g., a personalization pattern. In one embodiment, the second laser-engraved image of the second layer 1102 can be laser-engraved directly on the outer surface of the second layer 1102 when the second layer 1102 is laser markable. For example, the second laser-engraved image can be laser-engraved on the transparent plug in the cutout window 1120. In one embodiment, the second layer 1102 can be laminated or otherwise covered with an additional external transparent layer, such as a laser markable film that can be added on top of the second layer 1102, the second laser-engraved image being engraved in a region of the external surface overlapping the cutout window in the second layer 1102.

The cutout window 1110 in the first layer 1101 can be positioned with respect to (e.g., aligned with, partially overlapping but not completely overlapping) the cutout window 1120 of the second layer 1102.

In one embodiment, the inner (top) surface of the second layer 1102 can include a second printed image. The second printed image on the inner surface of the second layer 1102 can include an interactive pattern. The second printed image can be printed on most or all of the inner surface of the second layer 1102, as illustrated in FIG. 11. The inner surface can therefore be high-resolution printed with the interactive pattern of the second printed image. In this manner, the first layer 1101 can include a first laser-engraved image having a first pattern (e.g., personalization pattern) that is laser-engraved on an outer (top) surface and a first printed image having a second pattern (e.g., interactive pattern) that is printed on an inner (bottom) surface of the first layer 1101. The first image of the first layer 1101 can be laser-engraved on a transparent window 1110. The second layer 1102 can also include a second laser-engraved image having a first pattern (e.g., personalization pattern) that is laser-engraved on an outer (bottom) surface and a second printed image having a second pattern (e.g., interactive pattern) that is printed on an inner (top) surface of the second layer 1102. The patterns on the second layer 1102 interact respectively with patterns on the first layer 1101. The second laser-engraved image of the second layer 1102 can be laser-engraved on a transparent window 1120. The transparent windows of each layer can partially overlap with each other. The printed images having an interactive pattern of each layer 1101, 1102 can face each other when the layers are assembled, while the laser-engraved images having a personalization pattern of each layer 1101, 1102 can be laser-engraved on the outer surfaces of the assembled substrate. The first pattern of each layer can be the same or different pattern, and the second pattern of each layer can be the same or different pattern.

As shown in FIG. 11, overlapping and asymmetrical alignment of different cutout windows on front and back allows for different zones of personalization. When the assembled substrate is viewed from the front (e.g., when facing the first layer 1101), a portion of the second printed image, having the interactive pattern, that is printed on the inner surface of the second layer 1102 can be visible through the transparent window of the first layer 1101. The interaction between the portion of the second printed image of the second layer 1102 and the first laser-engraved image of the first layer 1101 that is laser-engraved on the transparent window of the first layer 1101 can create a visual effect of movement, e.g., the Moiré pattern, when the viewing angle changes.

Similarly, when the assembled substrate is viewed from the back (e.g., when facing the second layer 1102), a portion of the first printed image that is printed on the inner surface of the first layer 1101 can be visible through the transparent window of the second layer 1102. The interaction between the portion of the first printed image of the first layer 1101 and the second laser-engraved image (having a personalization pattern) of the second layer 1102 that is laser-engraved on the transparent window of the second layer 1102 can create a visual effect of movement, e.g., the Moiré pattern, when the viewing angle changes. As illustrated in FIG. 11, when viewed from the front, an overlapping region of the second laser-engraved image of the second layer 1102 can be visible through the transparent window of the first layer 1101 (Zone 3A). When viewed from the back, an overlapping region of the first laser-engraved image of the first layer 1101 can be visible through the transparent window of the second layer 1102 (Zone 3B). The overlapping regions can be seen because the windows are transparent in both layers.

This substrate allows for three dynamic zones for different fields of data, graphics or different axes of personalization. The pre-printed images in zones 1 and 2 as illustrated in FIG. 11 minimize laser through-put time. Only Zone 3 (Zone 3A or Zone 3B) uses external front and external back side laser engraved images to create a dynamic pattern with different patterns on each side. This combination creates three different patterns out of only 1 window.

In one embodiment, as illustrated in FIG. 11, the shape of the cutout windows is hexagonal allowing to create a cube effect with a different dynamic pattern effect on the top and/or bottom from the lateral sides.

The intervening layer 1103 creates a space between images on layers of the security feature in order to create a visual effect of movement between the images. In one embodiment, the spacer layer itself can be printed (e.g., via gravure printing or flex printing) with one of the patterns.

In one embodiment, the third layer 1103 (spacer layer) can be laser markable and can form protrusions that can fill the cutout windows on top and bottom when the third layer 1103 is placed between the first and second layers, thus removing the need for the external transparent laser markable films on the first and second layers, reducing the number of layers but making this spacer layer more complex.

In one embodiment, a surface of the spacer layer 1103 can be printed with a personalization pattern and/or an interactive pattern in addition to or in place of the adjacent inner surfaces of respectively the first layer 1101 or the second layer 1102.

In one embodiment, the images on the outer surfaces of each layer 1101, 1102 can be laser-engraved on a laser-markable film that is then deposited on the outer surfaces of each layer. For example, the first laser-engraved image of the first layer 1101 can be laser engraved on a transparent, laser-markable film on the first layer 1101 at the location of the window 1110 in the first layer 1101. The first layer 1101, as used herein, can refer to the combination of the first layer and the transparent, laser-markable film. The second laser-engraved image of the second layer 1102 can be laser engraved on a transparent laser-markable film on the second layer 1102 at the location of the cutout 1120 in the second layer 1102. The second layer 1102, as used herein, can refer to the combination of the second layer and the transparent laser-markable film. The laser engraving can be performed after the substrate is assembled because only the outer surfaces of each layer need to be engraved, thus improving efficiency and reducing laser throughput time.

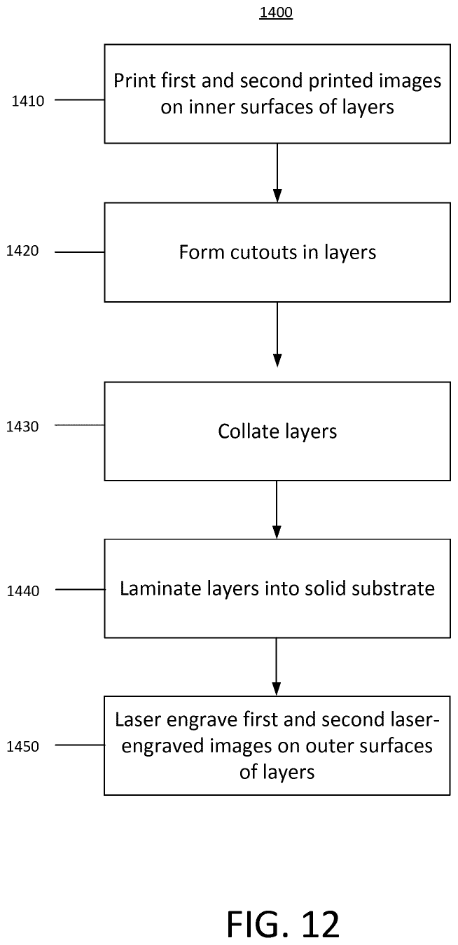

FIG. 12 is a method 1400 of creating the security feature with the interactive, second image pattern high resolution pre-printed on internal sides of first 1101 and second 1102 opaque layers and the personalization, first image pattern laser-engraved on the external surfaces of the first 1101 and second 1102 layers. The first pattern can be laser-engraved on laser markable films above the cutout or transparent or translucent spacer plug in each layer to form the first laser-engraved image and the second laser-engraved image, a transparent intervening layer 1103 being located in between both opaque layers 1101 and 1102, according to one embodiment. In step 1410, first and second printed images, including the interactive patterns, are printed on the first 1101 and second 1102 layers. The interactive pattern images can be pre-printed on complete inner surfaces of layer 1102, 1101, or at least in the vicinity of the cutout window of inner surfaces of layer 1102, 1101, especially on the inner surface of layer facing the other layer cutout window. In step 1420, a cutout 1110, 1120 can be made in each of the layer 1101 and the layer 1102, respectively. In one embodiment, these steps can be reversed.

In step 1430, the layers of the substrate can be assembled and collated. The assembled layers can include the layers 1101 and 1102 and 1103 (“core layers” collectively). In one embodiment, the assembled layers can include laser-markable transparent films on the first layer 1101 and/or the second layer 1102. The cutouts of the first layer and the second layer can be advantageously off-center and not exactly aligned. In one embodiment, the third 1103 layer can be a complete layer between the first 1101 layer and the second 1102 layer or can be a transparent plug positioned in the see-through window created by the cutouts. In step 1440 the layers assembled are fused together into a solid substrate, by lamination specially. In step 1450, the first and second laser-engraved images having the personalization pattern are laser engraved on outer surfaces respectively of layers 1101, 1102.

The combination of the laser-engraved images and the printed (or pre-printed) images on one or both internal surfaces interacting between the laser-engraved images creates a hybrid security feature that can include personalized data due to the laser engraving performed in the last steps of manufacturing of the substrate, and the pre-printed images allow for an accelerated process. The laser engraving process can be used to create personalized patterns or images that are different for each substrate that is fabricated. This combination allows for a strong security feature, thanks to its conserved dynamic effect that can be customized, since a static feature is more prone to counterfeit attack. In one embodiment, the hybridization can also use a color printing image on the one or both internal surfaces interacting between the laser engraved images, thereby increasing the complexity of the security feature and allowing more chromatic effects to be seen, which increases the counterfeit protection as well.

In one embodiment, the methods of FIG. 9 and FIG. 12 can be applied to a sheet of substrates. For example, the laser marking can be repeatedly applied to create image markings on substrates at different locations on the sheet. In one example, a sheet of security feature images can be printed. In one embodiment, the layers of the substrate can be sealed using a vacuum or heating process prior to the image fabrication or after image fabrication. The security feature of the present disclosure can be manufactured using a laser that can be programmed to engrave a certain image or pattern on a laser-markable substrate. The laser pattern or profile can be modified to engrave different images or patterns for each substrate. For example, the laser can be programmed with a sequence of laser patterns or profiles to engrave a series of different images or patterns on substrates. The different images or patterns can be unique images and/or can correspond to personalized data. In this manner, the security feature as described herein can be easily customizable while being fabricated in a single manufacturing process. Unique and varying security features can be easily applied to personalized security documents such as identification cards or documents, payment cards, etc. in a mass manufacturing process. The security feature also creates a complex visual effect that is difficult to counterfeit.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system modules and components in the embodiments described above should not be understood as requiring such separation in all embodiments, and it should be understood that the described components and systems can generally be integrated together in a single component or packaged into multiple components.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Obviously, numerous modifications and variations are possible in light of the above teachings. It is therefore to be understood that within the scope of the appended claims, embodiments of the present disclosure may be practiced otherwise than as specifically described herein.

Embodiments of the present disclosure may also be as set forth in the following parentheticals.

(1) A substrate for security verification, comprising: a first substrate layer including a first transparent region; a second substrate layer including a second transparent region; and an intervening substrate layer between the first substrate layer and the second substrate layer including an intervening transparent region positioned with respect to the first and second transparent regions, wherein the first substrate layer includes a first image that is laser-engraved on the first transparent region and the second substrate layer includes a second image deposited on the second transparent region, the first image and the second image being configured to interact to create a visual dynamic pattern when a viewing angle of the substrate changes.

(2) The substrate of (1), wherein the second image is laser-engraved on the second transparent region.

(3) The substrate of (1) to (2), wherein the intervening layer is opaque and the intervening transparent region is formed by a transparent plug inserted in a cutout through a body of the intervening layer, and a first surface of the transparent plug forms the first transparent region of the first substrate layer and/or a second surface of the transparent plug forms the second transparent region of the second substrate layer.

(4) The substrate of (1) to (3), wherein the intervening transparent region is formed by a transparent plug inserted in a cutout through a body of the intervening layer and the second image is printed on the transparent plug with optical variable material ink or colored ink.

(5) The substrate of (1) to (4), wherein a thickness of the intervening substrate layer is at least 0.1 millimeters.

(6) The substrate of (1) to (5), wherein a combined thickness of the substrate layers is at least 0.1 millimeters.

(7) The substrate of (1) to (6), wherein the first laser-engraved image includes personalized data via a pattern of dots and/or lines in greyscale.

(8) A substrate for security verification, comprising a first substrate layer including a first transparent, laser-markable region; a second substrate layer including a second transparent region; and an intervening substrate layer between the first substrate layer and the second substrate layer including an intervening transparent region positioned with respect to the first transparent, laser-markable region and the second transparent region, wherein a first outer surface of the first substrate layer includes a first laser-engraved image on the first transparent, laser-markable region, a first inner surface of the first substrate layer or a second inner surface of the second surface layer includes a printed image, a second outer surface of the second substrate layer includes a second image deposited on the second transparent region, and the first transparent, laser-markable region and the second transparent region are partially overlapping.

(9) The substrate of (8), wherein the first inner surface of the first substrate layer and the second inner surface of the second surface layer include the printed image, and the second transparent region is laser-markable.

(10) The substrate of (8) to (9), wherein the first transparent, laser-markable region is formed by a first cutout in the first substrate layer and the second transparent region is formed by a second cutout in the second substrate layer.

(11) The substrate of claim (8) to (10), wherein the first cutout or the second cutout is filled with a transparent plug.

(12) The substrate of (8) to (11), wherein the first laser-engraved image includes personalized data via a pattern of dots and/or lines in greyscale.

(13) The substrate of (8) to (12), wherein a thickness of the intervening substrate layer is at least 0.1 millimeters.

(14) The substrate of (8) to (13), wherein the first substrate layer includes a first transparent, laser-markable film on the first outer surface or the second substrate layer includes a second transparent, laser-markable film on the second outer surface.

(15) A method of forming a substrate for security verification, comprising: collating a first substrate layer having a first transparent region, a second substrate layer having a second transparent region, and an intervening substrate layer having an intervening transparent region between the first substrate layer and the second substrate layer; engraving a first image via laser engraving on the first transparent region of the first substrate layer; and depositing a second image on the second transparent region of the second substrate layer, wherein the intervening transparent region is positioned with respect to the first transparent region and the second transparent region.

(16) The method of (15), further comprising forming a cutout in the intervening substrate layer and depositing a transparent plug in the cutout to form the intervening transparent region.

(17) The method of (15) to (16), wherein depositing the second image further comprises engraving the second image via laser engraving.

(18) The method of (15) to (17), further comprising printing a printed image on an opaque inner surface of the first substrate layer or the second substrate layer, wherein the printed image surrounds the first transparent region or the second transparent region.

(19) The method of (15) to (18), wherein a thickness of the intervening substrate layer is at least 0.1 millimeters.

(20) The method of (15) to (19), wherein the first image includes personalized data and the second image includes a pattern of dots and/or straight lines.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A substrate for security verification, comprising:
a first substrate layer including a first transparent region;
a second substrate layer including a second transparent region; and
an intervening substrate layer between the first substrate layer and the second substrate layer including an intervening transparent region positioned with respect to the first and second transparent regions, wherein
the first substrate layer includes a first image that is laser-engraved on the first transparent region and the substrate includes a second image deposited thereon the second image including a depth map having different density in positions that correspond to regions of depth or distance in the first image, and the first image and the second image being configured to interact to create a visual dynamic pattern when a viewing angle of the substrate changes.

2. The substrate of claim 1, wherein the second image is laser-engraved in, or offset printed on, the second transparent region.

3. The substrate of claim 1, wherein the intervening layer is opaque and the intervening transparent region is formed by a transparent plug inserted in a cutout through a body of the intervening layer, wherein the second image is one of laser-engraved in, or offset printed on, a surface of the transparent plug.

4. The substrate of claim 1, wherein the intervening transparent region is formed by a transparent plug inserted in a cutout through a body of the intervening layer and the second image is printed on the transparent plug with optical variable material ink or colored ink.

5. The substrate of claim 1, wherein a thickness of the intervening substrate layer is at least 0.1 millimeters.

6. (previously presented The substrate of claim 1, wherein a combined thickness of the substrate layers is at least 0.1 millimeters and the first image or the second image has a resolution of between and including 400 dpi to 1200 dpi.

7. The substrate of claim 1, wherein the first laser-engraved image includes personalized data via a pattern of dots and/or lines in greyscale.

8. A substrate for security verification, comprising:
a first opaque substrate layer including a first transparent, laser-markable region;
a second opaque substrate layer including a second transparent region; and
an intervening substrate layer between the first substrate layer and the second substrate layer including an intervening transparent region positioned with respect to the first transparent, laser-markable region and the second transparent region, wherein
a first outer surface of the first substrate layer includes a first laser-engraved image on the first transparent, laser-markable region,
a first inner surface of the first substrate layer and a second inner surface of the second surface layer include a printed image,
a second outer surface of the second substrate layer includes a second image deposited on the second transparent region, and
the first transparent, laser-markable region and the second transparent region are only partially overlapping.

9. The substrate of claim 8, wherein the second image includes a depth map having different density in positions that correspond to regions of depth or distance in the first image, and the first image and the second image being configured to interact to create a visual dynamic pattern when a viewing angle of the substrate changes.

10. The substrate of claim 8, wherein the first transparent, laser-markable region is formed by a first cutout in the first substrate layer and the second transparent region is formed by a second cutout in the second substrate layer, and wherein the first cutout or the second cutout is filled with a transparent plug, and wherein the first inner surface printed image and the second inner surface printed image are different images.

11. (canceled)

12. The substrate of claim 8, wherein the first laser-engraved image includes personalized data via a pattern of dots and/or lines in greyscale.

13. The substrate of claim 8, wherein the intervening substrate layer includes a transparent plug in the intervening transparent region, wherein a third image is deposited on the transparent plug.

14. The substrate of claim 8, wherein the first substrate layer includes a first transparent, laser-markable film on the first outer surface or the second substrate layer includes a second transparent, laser-markable film on the second outer surface.

15. A method of forming a substrate for security verification, comprising:
removing a plug of material from an opaque intervening substrate layer to form a cutout and inserting a transparent plug into the cutout;
collating a first substrate layer having a first transparent region, a second substrate layer having a second transparent region, and the intervening opaque substrate layer;
engraving a first image via laser engraving on the first transparent region of the first substrate layer;
depositing a second image on the second transparent region of the second substrate layer, and
depositing a third image on the transparent plug, wherein
the transparent plug is positioned to at least partially overlap the first transparent region and the second transparent region.

16. The method of claim 15, wherein the second image includes a depth map having different density in positions that correspond to regions of depth or distance in the first image, and the first image and the second image being configured to interact to create a visual dynamic pattern when a viewing angle of the substrate changes.

17. The method of claim 15, wherein depositing the second image further comprises engraving the second image via laser engraving.

18. The method of claim 15, further comprising printing a printed image on an opaque inner surface of the first substrate layer or the second substrate layer, wherein the printed image surrounds the first transparent region or the second transparent region.

19. The method of claim 15, wherein a thickness of the intervening substrate layer is at least 0.1 millimeters, and a depth of the first image or the second image is up to 400 microns.

20. The method of claim 15, wherein the first image includes personalized data and the second image includes a pattern of dots and/or straight lines.

21. The substrate of claim 1, wherein the first transparent region is formed by a first cutout in the first substrate layer and the second transparent region is formed by a second cutout in the second substrate layer, and wherein the first cutout or the second cutout is filled with a transparent plug.
